(19) United States
(12) Patent Application Publication
(10) Pub. No.: US 2009/0239003 A1
(43) Pub. Date: Sep. 24, 2009

(54) Optical plate, backlight module and liquid crystal display using the same

(75) Inventors: Yao-Lung Wang, Hsin-Chu (TW); Hsin-An Cheng, Hsin-Chu (TW); Yang-Chu Lin, Hsin-Chu (TW); Hai-En Tsai, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/149,306

(22) Filed: Apr. 30, 2008

(30) Foreign Application Priority Data
Mar. 18, 2008 (TW) 97109556

(51) Int. Cl. C09K 19/00; B32B 3/10

(52) U.S. Cl. 428/1.6; 428/131

(57) ABSTRACT

An optical plate comprising a base having a plurality of protrusions and flat portions, wherein the protrusions and the flat portions are arranged alternately; at least one auxiliary structure, formed on the protrusions, having birefringence; and a matching layer formed on the base and the auxiliary structure is provided.

This application claims the benefit of Taiwan Patent Application Serial No. 97109556, filed Mar. 18, 2008, the subject matter of which is incorporated herein by reference.

### BACKGROUND OF THE INVENTION

1. Field of the Invention

The present invention generally relates to an optical plate, a backlight module using the same and a liquid crystal display panel using the same, and especially relates to an optical plate having better light recycling.

2. Description of Related Art

Liquid crystal displays are commonly used for digital cameras, personal digital assistants, mobile phones and television etc. Besides its basic function of displaying, better backlight modules are becoming important therefore.

As mentioned, how to improve the power consumption and light recycling has become one of the most important topics.

Referring to FIG. 1, FIG. 1 shows a conventional liquid crystal display. Liquid crystal display 1 includes liquid crystal display panel 12, polarizers 14A and 14B attached to the upper and lower surfaces of the liquid crystal display panel 12, respectively, and backlight module 10 located beneath the liquid crystal display panel 12. Liquid crystal display panel 12 includes upper and lower substrates, and liquid crystal layer sealed therebetween, which is known by persons having ordinary skill in the art. Further explanations are omitted. Backlight module 10 is taken a direct type backlight module for an example. Backlight module 10 includes a plurality of light sources 16. The light sources 16 provide light to the liquid crystal display panel 12 for displaying desired images. Light includes S-polarized light 16S and P-polarized light 16P. Polarizer 14A only permits S-polarized light 16S to pass there through and absorbs/reflects P-polarized light 16P, and therefore S-polarized light 16S is provided to liquid crystal display panel 12. Direction of polarized axis of polarizer 14B is perpendicular to that of polarizer 14A, so polarizer 14B permits P-polarized light 16P to pass there through and absorbs/reflects S-polarized light 16S.

As mention above, because polarizer 14A only permits S-polarized light 16S to pass there through and absorbs/reflects P-polarized light 16P, P-polarized light 16P emitted by light source 16 will pass through polarizer 14A and then transfer to P-polarized light 16P′ by liquid crystal of the liquid crystal display panel 12, wherein the P-polarized light 16P′ can pass through polarizer 14B, therefore liquid crystal display panel 12 can achieve display results.

However, S-polarized light 16S provided by light source 16 is half of the total light from the light source 16. In other words, P-polarized light 16P which is half of the total light from the light source 16 is wasted and without use. As a result, for backlight module 10, low light usage is a problem. How to improve light recycling of backlight module 10 is what engineers want to study.

### SUMMARY OF THE INVENTION

Accordingly, the present invention is directed to an optical plate for providing better light recycling.

The present invention is also directed to an optical plate for providing specific polarized light.

An objective of the present invention is to increase efficiency of backlight module, decrease power consumption and lower cost by using the optical plate provided by the embodiments of the present invention.

In accordance with the above objective and other objectives, the present invention provides an optical plate.

In accordance with the above objectives and other objectives, the present invention provides a liquid crystal display panel.

In accordance with the above objective and other objectives, the present invention provides a liquid crystal display.

In an embodiment of the present invention, the optical plate comprises a substrate having a plurality of protrusions and a plurality of flat portions, wherein the protrusions and the flat portions are arranged alternately; at least one auxiliary structure disposed on the protrusions wherein the at least one auxiliary structure has a birefraction index; and an adjusting layer disposed on the substrate and the protrusions.

In an embodiment of the present invention, a backlight module comprises an optical plate comprising a substrate having a plurality of protrusions and a plurality of flat portions, wherein the protrusions and the flat portions are arranged alternately; at least one auxiliary structure disposed on the protrusions wherein the at least one auxiliary structure has a birefraction index; and an adjusting layer disposed on the substrate and the protrusions; and at least one light source disposed adjacent to the optical plate.

In an embodiment of the present invention, a liquid crystal comprises an optical plate, comprising a substrate having a plurality of protrusions and a plurality of flat portions, wherein the protrusions and the flat portions are arranged alternately; at least one auxiliary structure disposed on the protrusions wherein the at least one auxiliary structure has a birefraction index; and an adjusting layer disposed on the substrate and the protrusions; a liquid crystal display panel disposed over the optical plate; and at least one light source disposed adjacent to the optical plate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional liquid crystal display.

FIG. 2 is a liquid crystal display according to the first embodiment of the present invention.

FIG. 3 is a liquid crystal display according to the second embodiment of the present invention.

FIG. 4 is a liquid crystal display according to the third embodiment of the present invention.

FIG. 5A is a liquid crystal display according to the fourth embodiment of the present invention.

FIG. 5B shows curves, of viewing angles vs. brightness of P-polarized light and S-polarized light provided by light source of the backlight module in FIG. 5A, simulated by TracePro.

FIG. 5C shows ratios, of comparison values of brightness of S-polarized light to P-polarized light, calculated from FIG. 5A.

FIGS. 6A and 6B are examples of substrates or auxiliary structures according to embodiments of the present invention.

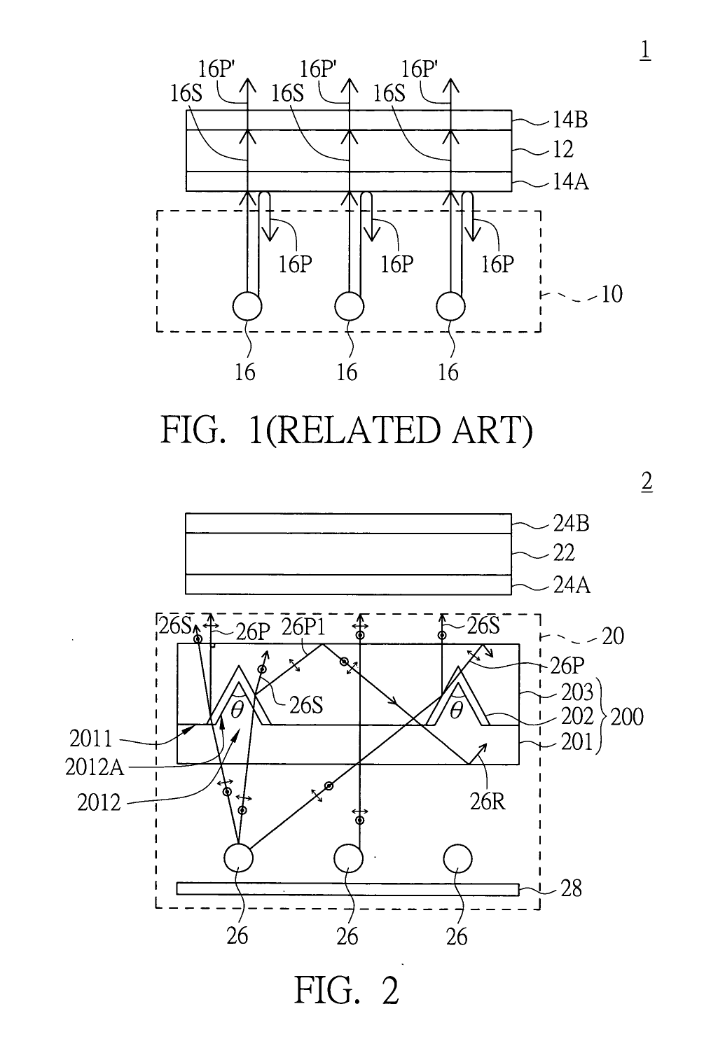

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

FIG. 2 is a liquid crystal display according to the first embodiment of the present invention. Liquid crystal display 2 comprises liquid crystal display panel 22, polarizers 24A and 24B attached to the upper and lower surfaces of the liquid crystal display panel 22, respectively, and backlight module 20 located beneath the liquid crystal display panel 22. Components of liquid crystal display panel 22 and polarizers 24A and 24B are shown as description of related art and detail description about them is omitted for convenience.

Backlight module 20 comprises optical plate 200 and light sources 26. Backlight module 20 of the present embodiment is taken direct type backlight module for an example. As shown, light sources 26 are located beneath the optical plate 200. Light sources 26, for example, are Cold cathode fluorescent lamps (CCFLs), External Electrode Fluorescent Lamps (EEFLs), mercury lamps, Halogen Lamps or light emitting diodes (LEDs). Reflector 28 may be selectively disposed beneath the light sources 26, for reflect light provided from the light sources 26 for increasing light usage. Optical plate 200 comprises substrate 201, auxiliary structures 202 and adjusting layer 203. Substrate 201 may be a diffuser for diffusing. Substrate 201 has protrusions 2012 and flat portions 2011. Protrusions 2012 and flat portions 2011 are arranged alternately. Auxiliary structures 202 are only formed on the protrusions 2012. Auxiliary structures 202 have a birefraction index. Auxiliary structures 202 are comprised of, for example, cured liquid crystal, Calcite, Cat's Eye, crystal or Ruby etc. Auxiliary structures 202 have a horizontal refraction index (Nx) of about 1.3 to about 2 and a vertical refraction index (Ny) of about 1.3 to about 2, preferably, a horizontal refraction index (Nx) of about 1.8 and a vertical refraction index (Ny) of about 1.49. Auxiliary structures 202 have a thickness of 0.1 micrometer to about 10 micrometer, preferably 1 micrometer. Preferably, a method for forming auxiliary structures 202 comprises, for example, forming bar-type liquid crystal or plate-type liquid crystal having high birefraction index on top of the protrusions 2012 by dropping; flowing the liquid crystal by gravity to cover sides 2012A of the protrusions 2012; and curing the liquid crystal by ultraviolet ray. Selectively, prior to the step of dropping the liquid crystal, form an alignment layer on the protrusions 2012 and then rubbing the alignment layer for having regular directions. Selectively, prior to the step of curing the liquid crystal, add monomer into the liquid crystal for enhancing curing efficiency of liquid crystal. Liquid crystal formed on the alignment layer has regular arrangements because of anchoring force, however, the way to make alignment layer have regular directions is not limited, which may be instead by emitting alignment layer using polarized ultraviolet ray (photo alignment) or sticking (SWV, for example). Cured liquid crystal becomes auxiliary structures 202. Cross section of protrusions 2012 comprise an isosceles triangle having a vertex angle of about 30 degree to about 70 degree. The pitch of the protrusions 2012 is about 10 micrometer to about 500 micrometer. Substrate 201 has a refraction index of about 1.5, for example, equal to that of the adjusting layer 203. The substrate and the adjusting layer are comprised of polymethylmethacrylate (PMMA), (Polyethylene Naphthalene ' PEN) or (Polyethylene terephthalate ' PET).

If light provided by light source 26 pass through substrate 201 and reaches side surface of the auxiliary structures 202, results of polarization division will happed. The light will transfer into S-polarized light 26S, P-polarized light 26P and P-polarized light 26P1. S-polarized light 26S will pass through upper surface of the adjusting layer 203 and reach polarizer 24A. If P-polarized light 26P is perpendicular to the upper surface of the adjusting layer 203, it will directly pass through the adjusting layer 203 and reach polarizer 24A. If P-polarized light 26P1 is not perpendicular to the upper surface of the adjusting layer 203, because refraction index of the adjusting layer 203 is greater than that of the air, it will transfer partial polarized light which is reflected by and goes away from the upper surface of the adjusting layer 203, and then pass into the substrate 201 again. Thereafter, it will become reflection light 26R totally reflected by the lower surface of the substrate 201 and then the above steps repeat over and over again. Light reaching the sides of the auxiliary structures 202 will be reflected and generate results of polarized division. As a result, P-polarized light 26P which is not directly provided to the polarizer 24A will be recycled to produce more S-polarized light 26S. As mentioned above, light usage will be increased efficiently, usage of enhancing light plate of backlight module 20 may be omitted, power consumption may be decreased and cost will be lowered.

### Second Embodiment

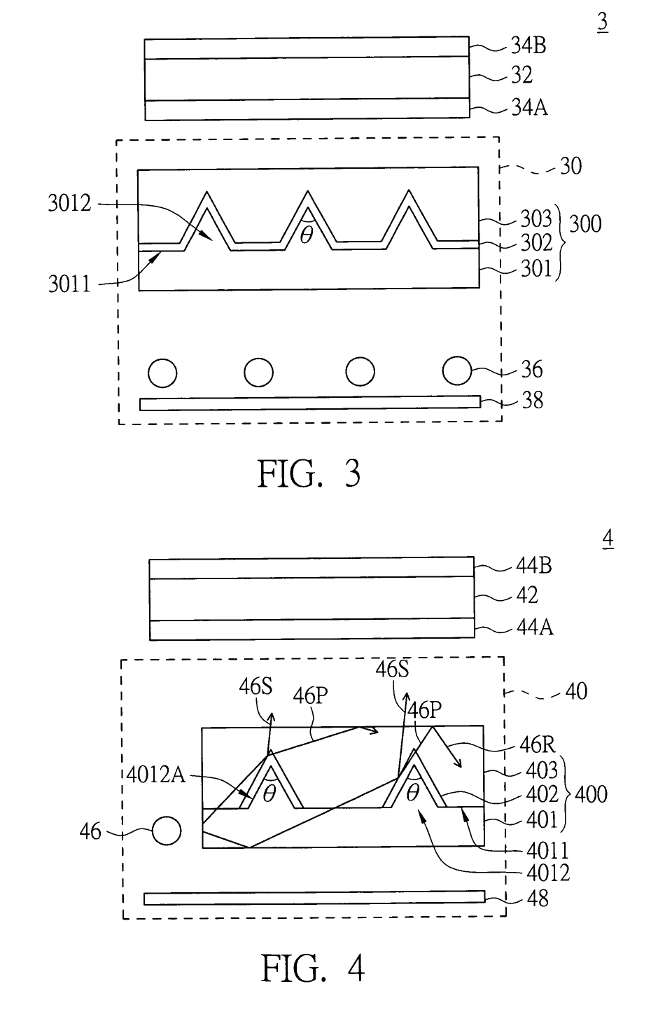

FIG. 3 is a liquid crystal display according to the second embodiment of the present invention. Liquid crystal display 3 comprises liquid crystal display panel 32, polarizers 34A and 34B attached to the upper and lower surfaces of the liquid crystal display panel 32, respectively, and backlight module 30 located beneath the liquid crystal display panel 32. Components of liquid crystal display panel 32 and polarizers 34A and 34B are shown as description of related art and detail description about them is omitted for convenience.

Backlight module 30 comprises optical plate 300 and light sources 36. Backlight module 30 of the present embodiment is taken direct type backlight module for an example. As shown, light sources 36 are located beneath the optical plate 300. Light sources 36, for example, are Cold cathode fluorescent lamps (CCFLs), External Electrode Fluorescent Lamps (EEFLs), mercury lamps, Halogen Lamps or light emitting diodes (LEDs). Reflector 38 may be selectively disposed beneath the light sources 36, for reflect light provided from the light sources 36 for increasing light usage. Optical plate 300 comprises substrate 301, auxiliary structure 302 and adjusting layer 303. Substrate 301 may be a diffuser for diffusing. Substrate 301 has protrusions 3012 and flat portions 3011. Protrusions 3012 and flat portions 3011 are arranged alternately. Unlike the first embodiment, in the present embodiment, auxiliary structure 302 is entirely formed on the upper surface of the substrate 301, in other words, auxiliary structure 302 is formed on all of the flat portions 3011 and protrusions 3012.

Size, materials, shapes or methods for forming the auxiliary structure 302 are as same as that of the first embodiment. Principles of light usage increase and light paths can be referred to the first embodiment, and detail description is omitted for convenience.

### Third Embodiment

FIG. 4 is a liquid crystal display according to the first embodiment of the present invention. Liquid crystal display 4 comprises liquid crystal display panel 42, polarizers 44A and 44B attached to the upper and lower surfaces of the liquid crystal display panel 42, respectively, and backlight module 40 located beneath the liquid crystal display panel 42. Components of liquid crystal display panel 42 and polarizers 44A and 44B are shown as description of related art and detail description about them is omitted for convenience.

Backlight module 40 comprises optical plate 400 and light sources 46. Backlight module 40 of the present embodiment is taken side type backlight module for an example. Substrate 401 can be a light guide plate for guiding light. Light sources 46 are located at one side of the substrate 401 as shown in FIG. 4. Light sources 46, for example, are Cold cathode fluorescent lamps (CCFLs), External Electrode Fluorescent Lamps (EEFLs), mercury lamps, Halogen Lamps or light emitting diodes (LEDs). Reflector 48 may be selectively disposed beneath the optical plate 400, for reflect light provided from the light sources 46 for increasing light usage. Substrate 401 has protrusions 4012 and flat portions 4011. Protrusions 4012 and flat portions 4011 are arranged alternately. Unlike the first embodiment, in the present embodiment, light provided by the light source 46 enters side of the optical plate 400. As shown in FIG. 4, light is reflected by the auxiliary structure 402 of the side of the protrusion 4012 to generate results of polarized division, and it transfers into S-polarized light 46S and P-polarized light 46P. S-polarized light 46S goes away from the adjusting layer 403 and reach polarizer 44A. If P-polarized light 46P is not perpendicular to the upper surface of the adjusting layer 403, because refraction index of the adjusting layer 403 is greater than that of the air, it will transfer partial polarized light which is reflected by and goes away from the upper surface of the adjusting layer 403, and then pass into the substrate 401 again. Thereafter, it will become reflection light totally reflected by the lower surface of the substrate 401 and then the above steps repeat over and over again. Light reaching the sides of the auxiliary structures 402 will be reflected and generate results of polarized division. As a result, P-polarized light 26P which is not directly provided to the polarizer 44A will be recycled to produce more S-polarized light 46S. As mentioned above, light usage will be increased efficiently, usage of enhancing light plate of backlight module 40 may be omitted, power consumption may be decreased and cost will be lowered.

Size, materials, shapes or methods for forming the auxiliary structure 402 are as same as that of the first embodiment. Principles of light usage increase and light paths can be referred to the first embodiment, and detail description is omitted for convenience.

### Fourth Embodiment

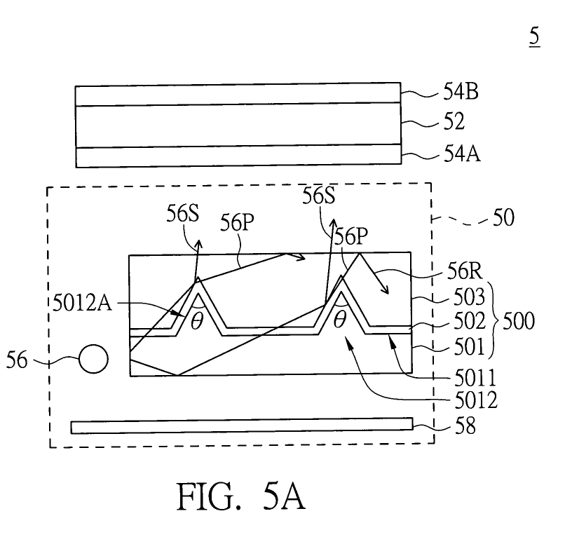

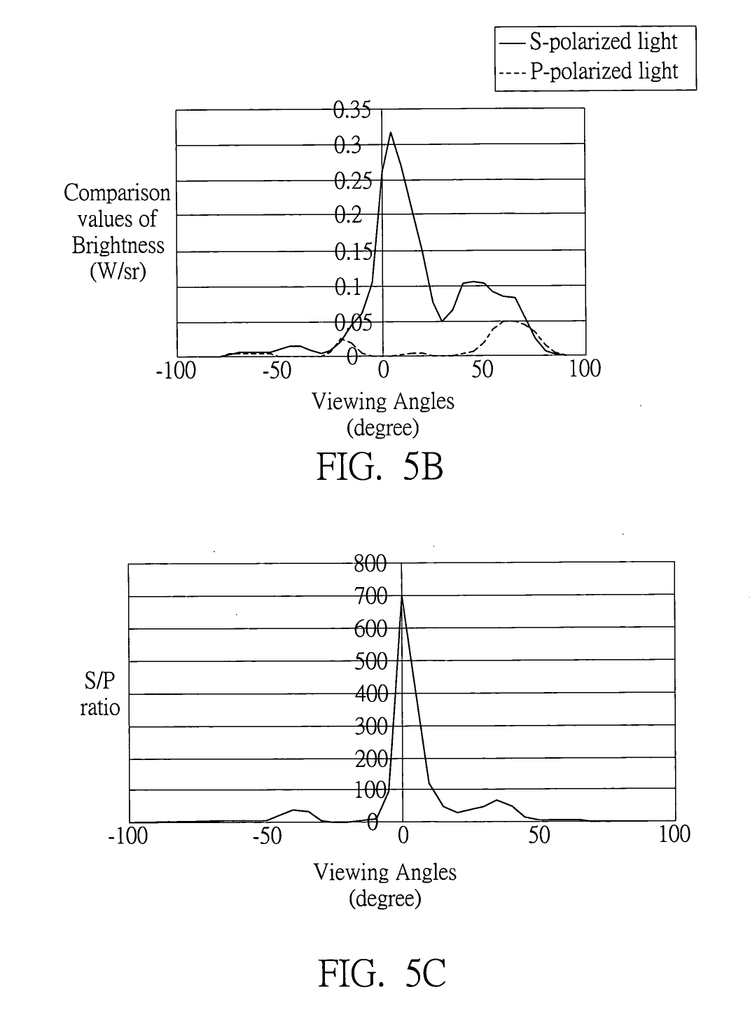

FIG. 5A is a liquid crystal display according to the first embodiment of the present invention. Liquid crystal display 5 comprises liquid crystal display panel 52, polarizers 54A and 54B attached to the upper and lower surfaces of the liquid crystal display panel 52, respectively, and backlight module 50 located beneath the liquid crystal display panel 52. Components of liquid crystal display panel 52 and polarizers 54A and 54B are shown as description of related art and detail description about them is omitted for convenience.

Most components and assembly of backlight module 50 is as shown in the third embodiment. Unlike the third embodiments, in the present embodiment, auxiliary structure 502 is entirely formed on the upper surface of the substrate 501. In other words, auxiliary structure 502 is on all of the protrusions 5012 and flat portions 5011.

FIG. 5B shows curves, of viewing angles vs. brightness of P-polarized light and S-polarized light provided by light source of the backlight module 50 in FIG. 5A, simulated by TracePro. In the present simulation, protrusion 5012 is an isosceles triangle having a vertex angle of about 60 degree. Pitch of the protrusions 5012 is about 50 micrometer. Auxiliary structure 502 has a horizontal refraction index of about 1.8 and a vertical refraction index of about 1.49. As shown in FIG. 5B, backlight module 50 provides more S-polarized light than P-polarized light. For 0 degree viewing angle, which means directly in front of the backlight module 50, measure the comparison values of brightness of P-polarized light and S-polarized light. S-polarized light has a comparison values of brightness of about 0.33, and that of the P-polarized light is about 4.7×10⁴. However, for 27 degree viewing angle, S-polarized light has a comparison values of brightness of about 0.05, and that of the P-polarized light is about 1×10−3. As a result, for small viewing angles, comparison values of brightness of S-polarized light are significantly greater than that of the P-polarized light. Therefore, light usage is successively improved.

FIG. 5C shows ratios, of comparison values of brightness of S-polarized light to P-polarized light, calculated from FIG. 5A. As shown in FIG. 5C, for 0 degree viewing angle, ratio of comparison values of brightness of S-polarized light to P-polarized light is up to 700. However, while using conventional DBEF film, ratio of comparison values of brightness of S-polarized light to P-polarized light is about 6. Therefore, the embodiments of the present invention can sufficiently achieve light polarized division and improve light usage successively.

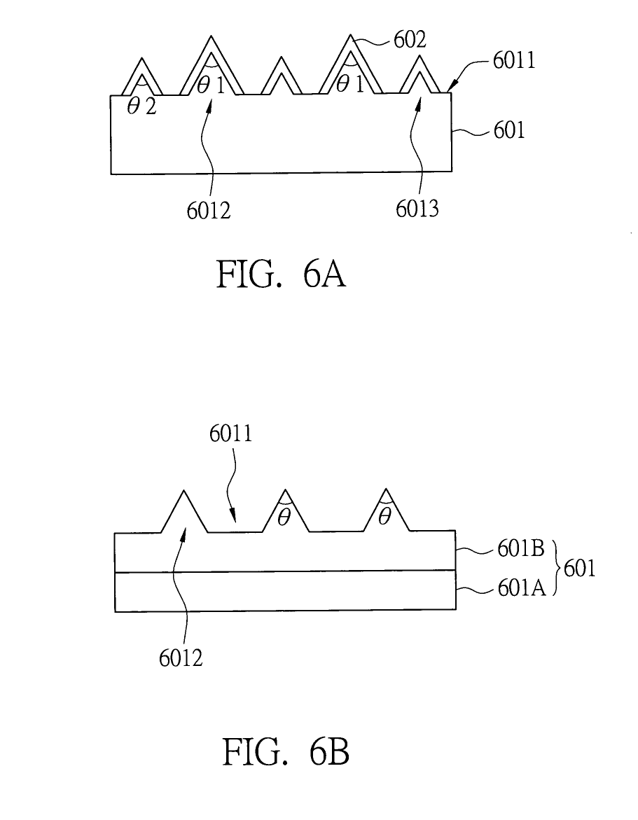

FIGS. 6A and 6B are examples of substrates or auxiliary structures according to embodiments of the present invention.

As shown in FIG. 6A, there are protrusions 6012 and flat portions 6011 formed on the upper surface of the substrate 601. Protrusions 6012 and flat portions 6011 are arranged alternately, however, which may be arranged uniformly or randomly. Particularly, although previous embodiments show protrusions having unique size, shape and material for example, size, shape and material of protrusions 6012 and 6013 can be selected and changed into different according designer's demands. As shown in FIG. 6A, protrusions 6012 are larger than protrusions 6013. Protrusions 6012, 6013 are arranged alternately. Auxiliary structure 602 can be only formed on the protrusions 6012, 6013, or entirely formed on the upper surface of the substrate 601 which means auxiliary structure 602 is formed on all of the flat portions 6011, protrusions 6012 and 6013. Another example of the substrate 601, in FIG. 6B, substrate 601 includes first base 601A and second base 601B. Second base 601B is formed on the first base 601A. Flat portions 6011 and protrusions 6012 are formed on the surface of the second base 601B. Materials, thickness and/or optical properties of the first base 601A and second base 601B can be the same or different. Materials of the first base 601A and second base 601B can be comprised of polymethylmethacrylate (PMMA), (Polyethylene Naphthalene ' PEN) or (Polyethylene terephthalate ' PET). For sure, variable types of the protrusions can refer to previous examples. Methods for forming auxiliary structures 602 and relationship between the substrate 601 can refer to previous embodiments of the present invention. Detail description is omitted for convenience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical plate, comprising:
a substrate having a plurality of protrusions and a plurality of flat portions, wherein the protrusions and the flat portions are arranged alternately;
at least one auxiliary structure disposed on the protrusions wherein the at least one auxiliary structure has a birefraction index; and
an adjusting layer disposed on the substrate and the protrusions.

2. The optical plate according to claim 1, wherein the adjusting layer is further disposed on the flat portions.

3. The optical plate according to claim 2, wherein the auxiliary structure is conformal with the upper surface of the substrate contacting the auxiliary structure.

4. The optical plate according to claim 1, wherein the auxiliary structure has a horizontal refraction index of about 1.3 to about 2 and a vertical refraction index of about 1.3 to about 2.

5. The optical plate according to claim 4, wherein the auxiliary structure has a horizontal refraction index of about 1.8 and a vertical refraction index of about 1.49.

6. The optical plate according to claim 1, wherein the auxiliary structure has a thickness of about 0.1 micrometer to about 10 micrometer.

7. The optical plate according to claim 1, wherein the auxiliary structure is comprised of cured liquid crystal, Calcite, Cat's Eye, crystal or Ruby.

8. The optical plate according to claim 7, wherein the cured liquid crystal comprises cured bar-type liquid crystal or cured plate-type liquid crystal.

9. The optical plate according to claim 1, wherein the auxiliary structure is only disposed on the protrusions.

10. The optical plate according to claim 1, wherein the protrusions include a plurality of first protrusions and a plurality of second protrusions, wherein one of the first protrusions has a size different from that of one of the second protrusions, and wherein the first protrusions and the second protrusions are arranged alternatively.

11. The optical plate according to claim 1, wherein the cross section of the protrusions comprises an isosceles triangle, and the isosceles triangle has a vertex angle of about 30 degree to about 70 degree.

12. The optical plate according to claim 1, wherein the pitch of the protrusions is about 10 micrometer to about 500 micrometer.

13. The optical plate according to claim 1, wherein the substrate has a refraction index equal to that of the adjusting layer.

14. The optical plate according to claim 1, wherein the substrate and the adjusting layer are comprised of polymethylmethacrylate (PMMA), (Polyethylene Naphthalene ' PEN) or (Polyethylene terephthalate ' PET).

15. The optical plate according to claim 1, wherein the substrate and the adjusting layer have a refraction index of about 1.5.

16. The optical plate according to claim 1, wherein the substrate comprises:
a first base; and
a second base formed on the first base, the protrusions and the flat portions being formed on the upper surface of the second base.

17. The optical plate according to claim 16, wherein the first base has a refraction index equal to that of the second base.

18. The optical plate according to claim 16, wherein the first base and the second base are comprised of polymethylmethacrylate (PMMA), (Polyethylene Naphthalene ' PEN) or (Polyethylene terephthalate ' PET).

19. A backlight module, comprising:
an optical plate, comprising:
a substrate having a plurality of protrusions and a plurality of flat portions, wherein the protrusions and the flat portions are arranged alternately;
at least one auxiliary structure disposed on the protrusions wherein the at least one auxiliary structure has a birefraction index; and
an adjusting layer disposed on the substrate and the protrusions; and
at least one light source disposed adjacent to the optical plate.

20. A liquid crystal, comprising:
an optical plate, comprising:
a substrate having a plurality of protrusions and a plurality of flat portions, wherein the protrusions and the flat portions are arranged alternately;
at least one auxiliary structure disposed on the protrusions wherein the at least one auxiliary structure has a birefraction index; and
an adjusting layer disposed on the substrate and the protrusions;
a liquid crystal display panel disposed over the optical plate; and
at least one light source disposed adjacent to the optical plate.
